(19) United States
(12) Patent Application Publication
(10) Pub. No.: US 2016/0017230 A1
(43) Pub. Date: Jan. 21, 2016

(54) Pulverulent Coated Flame Retardant

(71) Applicant: CLARIANT INTERNATIONAL LTD., Muttenz (CH)

(72) Inventors: Daniela MARRWITZ, Kelkheim (DE); Annemarie STORK, Mannheim (DE)

(73) Assignee: CLARIANT INTERNATIONAL LTD., Muttenz (CH)

(21) Appl. No.: 14/773,165

(22) PCT Filed: Feb. 27, 2014
(86) PCT No.: PCT/EP2014/000516

§ 371 Date: Sep. 4, 2015

(30) Foreign Application Priority Data
Mar. 9, 2013 (DE) 10 2013 004 170.8

(51) Int. Cl. C09K 21/04; C09D 183/04; B05D 1/02; C08K 9/06

(52) U.S. Cl. CPC C09K 21/04; C08K 9/06; C09D 183/04; B05D 1/02

(57) ABSTRACT

The invention relates to a pulverulent coated flame retardant, characterized in that the flame retardant is phosphorus-containing and/or nitrogen-containing flame retardant and silazanes and/or silazane/organosiloxane mixtures are used as coating agent. The invention also relates to a process for producing such flame retardants and to the use thereof.

The invention relates to a pulverulent coated flame retardant, to a process for production of same, and to use of same.

It is known that ammonium phosphates, ammonium polyphosphates, melamine phosphates, melamine borates, and melamine cyanurates are used as halogen-free flame retardants inter alia for plastics and textiles, and in intumescent coatings.

Although these flame retardants provide good flame retardancy to the plastics, atmospheric moisture and other environmental effects cause migration of same by way of example out of the plastics over the course of time, because the flame retardants are to some extent water-soluble.

There has therefore been no lack of attempts to render flame retardants resistant to hydrolysis and also resistant to other effects, so that they retain their effectiveness in the appropriate plastic.

By way of example, DE-A-3316880 describes a process for the production of hydrolysis-resistant, water-insoluble ammonium polyphosphate. Here, ammonium polyphosphate is coated with melamine-formaldehyde resins or with phenol-formaldehyde resins.

The disadvantage of this coating process is the use of the toxic compound formaldehyde per se, and also some release of the formaldehyde during the production and use of flame-retardant plastics, textiles, or intumescent coatings.

When melamine-formaldehyde-coated ammonium polyphosphate is used in the textile application it is necessary to comply with the stringent OkoTex-Standard 100. Permissible product-class-dependent maximal formaldehyde release is 0.1 ppm. The maximum workplace concentration value for formaldehyde itself is 0.5 ppm. Alternatives to formaldehyde are therefore being sought.

JP-A-2006028488 describes an ammonium polyphosphate surface-treated with organosilicone resins in order to reduce the water-solubility of the ammonium polyphosphate. Application sector here is textile coating in motor vehicles.

EP-A-0970985 moreover describes a process for the production of surface-modified flame retardants by using organofunctional silanes and oligomeric organosiloxanes. Water-solubility is thus reduced by from 17 to at most 60% in comparison with untreated flame retardant.

It was therefore an object to achieve a further reduction in the water-solubility of certain flame retardants.

Said object is achieved by using silazanes and, respectively, mixtures of silazanes with organosiloxanes as coating material.

Surprisingly, it has been found that the water-solubility of flame retardants can be reduced markedly by using silazanes and, respectively, mixtures of silazanes with organosiloxanes as coating material.

There is moreover a resultant reduction in the migration of the flame retardants out of plastics and in the viscosity of the flame retardant.

The invention therefore provides a pulverulent coated flame retardant which is a phosphorus-containing and/or nitrogen-containing flame retardant where silazanes and/or silazane-organosiloxane mixtures are used as coating material.

It is preferable that the phosphorus-containing and/or nitrogen-containing flame retardant is ammonium orthophosphate, ammonium diphosphate, ammonium polyphosphate, melamine phosphate, melamine orthophosphate, melamine diphosphate, melamine polyphosphate, melamine pyrophosphate, melamine borate, melamine cyanurate, melamine borophosphate, melamine 1,X-phthalate, and/or melamine oxalate; melem, melam, melon, melam polyphosphate, melem polyphosphate and/or melon polyphosphate.

It is preferable that the phosphorus-containing and/or nitrogen-containing flame retardant is ammonium phosphate and/or ammonium polyphosphate.

Preferred silazanes used comprise dimeric and/or polymeric silazanes of the formula (1),

—(SiR′R″—NR′″)ₙ— (1)

where R′, R″, and R′″ are identical or different and are mutually independently hydrogen or an optionally substituted alkyl, aryl, vinyl, or (trialkoxysilyl)alkyl moiety, where n is an integer and n is such that the number-average molar mass of the silazane is from 70 to 150 000 g/mol.

Other preferred silazanes used comprise those of the formula (2),

—(SiR′R″−NR′″)ₙ—(SiR*R**—NR***)ₚ — (2)

where R′, R″, R′″, R*, R**, and R*** mutually independently are hydrogen or an optionally substituted alkyl, aryl, vinyl, or (trialkoxysilyl)alkyl moiety, and n and p are such that the number-average molar mass of the silazane is from 150 to 150 000 g/mol.

Silazanes that are particularly suitable here are those of the formula 1 and/or 2 in which R′, R″, R′″, R*, R**, and R*** are mutually independently a moiety from the group of hydrogen, methyl, ethyl, propyl, isopropyl, butyl, isobutyl, tert-butyl, phenyl, vinyl, or 3-(triethoxysilyl)propyl, 3-(trimethoxysilyl)propyl.

In the silazane of the formula (2) it is preferable that
R′, R′″, and R*** are hydrogen and R″, R*, and R** are methyl and/or vinyl, or
R′ and R′″ are hydrogen, R″, R*, and R** are methyl and R*** is (trialkoxysilyl)propyl, or
R′, R′″, R*, and R*** are hydrogen, and R″ and R** are methyl.

It is preferable that the organosiloxane of the silazane-organosiloxane mixtures is alkoxysiloxane and/or oligomeric alkoxysiloxane comprising linear, branched, functionalized, and/or cyclic alkyl, alkoxy, aminoalkyl, aryl and/or vinyl groups.

It is preferable that the organosiloxane is 3-am inopropyltrialkoxysilane, 3-amino-propylmethyldialkoxysilane, 3-glycidyloxypropyltrialkoxysilane, 3-acryloxypropyl-trialkoxysilane, 3-methacryloxypropyltrialkoxysilane, vinyltrialkoxysilane, vinyl-tris(2-methoxyethoxy)silane, propyltrialkoxysilane, butyltrialkoxysilane, pentyl-trialkoxysilane, hexyltrialkoxysilane, heptyltrialkoxysilane, octyltrialkoxysilane, propylmethyldialkoxysilane, butylmethyldialkoxysilane, and/or phenyltrialkoxy-silane, phenylmethyldialkoxysilane, and/or is an oligomeric vinyl-functional, aryl-functional, and/or alkyl-functional alkoxysiloxane.

The invention also comprises a pulverulent coated flame retardant wherein from 1 to 50 parts by weight of silazane or of a mixture of silazane and organosiloxane are applied to 100 parts by weight of flame retardant.

The invention also provides a process for the production of a pulverulent coated flame retardant as claimed in one or more of claims 1 to 10, which comprises applying the silazanes and/or silazane-organosiloxane mixtures directly or in the form of a solution to the pulverulent flame retardant.

It is preferable that the silazanes and/or silazane-organosiloxane mixtures are applied by spraying or injection, or in droplet form, or by pouring onto the pulverulent flame retardants kept in motion via mixers, kneaders, stirrers, or gas.

The conduct of the process of the invention is preferably such that the temperature of the pulverulent flame retardant has been controlled in advance to from 10 to 200° C.

It is preferable that hardening is then carried out for from 5 min to 24 h at temperatures of from 10 to 200° C.

Preference is also given to a process which comprises suspending the flame retardant in a solvent and heating with the silazanes and/or silazane-organo-siloxane mixtures to from 10 to 200° C. for from 5 min to 24 h, with stirring.

Here again, it is preferable that hardening is then carried out for from 5 min to 24 h at temperatures of from 10 to 200° C.

It is preferable that the ratio by weight of silazane to organosiloxane in the silazane-organosiloxane mixtures applied is from 100:0 to 1:99.

It is particularly preferable that the ratio by weight of silazane to organosiloxane in the silazane-organosiloxane mixtures applied is from 75:25 to 1:99.

Finally, the invention also provides the use of the pulverulent coated flame retardant as claimed in one or more of claims 1 to 10 in intumescent coatings, polyolefins and other polymers, and also textiles.

The polysilazanes correspond in essence by way of example to the following structures:

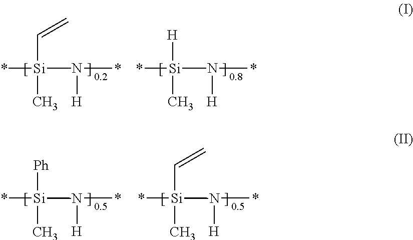

There are various ways of conducting the process of the invention.

In one embodiment of the process, the silazane and, respectively, the mixture of silazane and organosiloxane is applied to the pulverulent flame retardant. The powder is kept in motion here, and the coating material is added in pure form or in solution (from 5 to 80% by weight) thereto. The application of the silazane and, respectively, of the mixture of silazane and organosiloxane can be achieved by spraying or injection, or in droplet form, or by pouring, while the flame retardant powder is kept in motion via mixers, kneaders, stirrers, or gas. Drying is then carried out at elevated temperature (from 10 to 200° C.) for from 5 min to 24 h.

It is preferable to keep the powder in motion in, or by using, the following assemblies: plowshare mixers, annular-gap and annular-layer mixers, intensive mixers, twin-shaft paddle mixers, free-fall mixers, conical-screw mixers, planetary mixing machines, double-cone mixers, fluidized-bed mixers, air-jet mixers, spray mixers, spray towers, tumbling mixers or container mixers, fluid mixers, and cooling mixers.

Of course, there are also suitable assemblies that are not listed here.

In another embodiment of the process, the flame retardant is suspended in a solvent and heated with the silazane and/or a silazane-organosiloxane mixture to from 10 to 200° C., preferably to from 50 to 180° C., for from 5 min to 24 h, with stirring. After filtering and washing, drying is carried out for from 5 min to 24 h at from 10 to 200° C.

It is preferable that from 1 to 30 parts by weight of silazane or a mixture of silazane and organosiloxane are applied to 100 parts by weight of flame retardant.

Examples of suitable organosiloxanes that can be used are Dynasylan AMEO, Dynasylan® PTEO, Dynasylan® OCTEO, Dynasylan® MTMS, Dynasylan® 6498, Dynasylan® 6490, and Protectosil® 166.

Particularly suitable solvents for the coating based on silazane are organic solvents. These are by way of example aliphatic or aromatic hydrocarbons, halogenated hydrocarbons, esters such as ethyl acetate or butyl acetate, ketones such as acetone or methyl ethyl ketone, ethers such as tetrahydrofuran or dibutyl ether, and also mono- and polyalkylene glycol dialkyl ethers (glymes), or a mixture of these solvents. When silazane-organosiloxane mixtures are used, use is also made of organic alcohols such as ethanol, isopropanol, and methanol, and also water as solvent.

It is preferable to use pulverulent flame retardants with average grain size from 1 to 100 pm.

Silazanes used are dimeric and polymeric silazanes of the formula (1) or of the formula (2) that are used as antigraffiti agents and in dirt-repellent coatings.

Examples of the silazanes used are KiON® HTA 1500, KiON® HTT 1800, KION® ML 33, KiON® ML 100, KiON® VL 100, Ceraset® PSZ 20, Ceraset® PSZ MS, and hexamethyldisilazane.

The pulverulent coated flame retardants of the invention as claimed in one or more of claims 1 to 10 are preferably used in intumescent coatings. A feature of intumescent coatings, also known as fire-protection coatings that form an insulating layer, is that in the event of fire, on exposure to an appropriate temperature, they foam, and this foaming of said fire-protection coating prevents, or at least hinders, the transfer of heat to steel structures, ceilings, walls, cables, pipes, and the like. This foam layer has a thickness of a number of centimeters, and for a certain period it prevents any direct effect of the fire on the materials and structures located under the foam layer.

Materials used in production of preferred fire-protection coatings that form an insulating layer are substances that in the event of fire have foam-forming and carbonizing effects, film-forming binders, blowing agents, and conventional auxiliaries and additives.

Film-forming binders used can by way of example be homopolymers based on vinyl acetate, copolymers based on vinyl acetate, ethylene, and vinyl chloride; based on vinyl acetate and on the vinyl ester of a carboxylic acid; based on vinyl acetate and di-n-butyl maleate, or acrylic ester; based on styrene and acrylic ester, and/or can be copolymers based on acrylic ester, vinyltoluene/acrylate copolymer, styrene/acrylate copolymer, vinyl/acrylate copolymer, or can be self-crosslinking polyurethane dispersions.

Particularly suitable foam-forming substances are ammonium salts of phosphoric acids and/or polyphosphoric acids. These can be coated or uncoated materials.

Carbohydrates, and preferably pentaerythritol, dipentaerythritol, tripentaerythritol, and/or polycondensates of pentaerythritol are used as carbonizing substances.

Suitable blowing agents are melamine and/or guanidine, and also salts of these, and/or dicyandiamides, and preferably melamine phosphate, melamine cyanurate, melamine borate, melamine silicate, and/or guanidine phosphate.

The fire-protection coating that forms an insulating layer can moreover comprise melamine polyphosphate, dialkylphosphinic salts, and other phosphorus compounds, and also the following auxiliaries and additives: glass fibers, mineral fibers, kaolin, talc powder, aluminum oxide, aluminum hydroxide, magnesium hydroxide, precipitated silicas, and silicates, and/or pulverized celluloses, etc.

The abovementioned fire-protection coatings (intumescent coatings) are predominantly used in the form of a spreadable, sprayable, or rollable paint for the protection of a very wide variety of substrates, preferably of steel, of wood, of electrical cables, and of pipes.

The pulverulent coated flame retardants of the invention as claimed in one or more of claims 1 to 10 are also preferably used in polyolefins.

Examples of preferred polyolefins are polymers of mono- and diolefins (e.g. ethylene, propylene, isobutylene, butene, 4-methylpentene, isoprene, butadiene, styrene), for example polypropylene, polyisobutylene, polybut-1-ene, poly-4-methylpent-1-ene, polystyrene, poly(p-methylstyrene), and/or poly(alpha-methylstyrene), polyisoprene, or polybutadiene, and polyethylene (optionally crosslinked), for example high-density polyethylene (HDPE), high-density high-molecular-weight polyethylene (HDPE-HMW), high-density ultrahigh-molecular-weight polyethylene (HDPE-UHMW), medium-density polyethylene (MDPE), low-density polyethylene (LDPE), linear low-density polyethylene (LLDPE), very low-density polyethylene (VLDPE), branched low-density polyethylene (BLDPE), and also polymers of cycloolefins, for example of cyclopentene or norbornene.

The abovementioned polyolefins, in particular polyethylenes and polypropylenes, are preferably produced as in the prior art, for example by free-radical polymerization (normally at high pressure and high temperatures), or by catalytic polymerization using transition metal catalysts.

Other preferred polymers are mixtures (blends) of the polyolefins listed above, e.g. polypropylene with polyisobutylene, polyethylene with polyisobutylene, polypropylene with polyethylene (e.g. PP/HDPE/LDPE), and mixtures of various polyethylene types (e.g. LDPE/HDPE).

Other preferred polymers are copolymers of mono- and diolefins with one another and of mono- and diolefins with other vinylic monomers, e.g. ethylene-propylene copolymers; LLDPE, VLDPE, and mixtures thereof with LDPE; propylene-but-1-ene copolymers, propylene-isobutylene copolymers, ethylene-but-1-ene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers, copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, and styrene-butadiene-alkyl methacrylate, styrene-maleic anhydride, styrene-acrylonitrile-methyl acrylate; mixtures of high impact resistance made of styrene copolymers and of another polymer, e.g. of a polyacrylate, of a diene polymer or of an ethylene-propylene-diene terpolymer; and also block copolymers of styrene, e.g. styrene-butadiene-styrene, styrene-isoprene-styrene, styrene-ethylene/butylene-styrene, or styrene-ethylene/propylene-styrene, and also graft copolymers of styrene or alpha-methylstyrene, e.g. styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene, and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these, for example those known as ABS polymers, MBS polymers, ASA polymers, or AES polymers; or else carbon monoxide copolymers of these, or ethylene-acrylic acid copolymers, and salts of these (ionomers), and also terpolymers of ethylene with propylene and with a diene, e.g. hexadiene, dicyclopentadiene, or ethylidenenorbornene; and mixtures of copolymers of this type with one another and/or with other polymers, e.g. polypropylene-ethylene-propylene copolymer, LDPE-ethylene-vinyl acetate copolymer, LDPE-ethylene-acrylic acid copolymer, LLDPE-ethylene-vinyl acetate copolymer, LLDPE-ethylene-acrylic acid copolymer, and alternating or random polyalkylene-carbon monoxide copolymers, and mixtures thereof with other polymers, for example polyamides.

However, the pulverulent coated flame retardants of the invention as claimed in one or more of claims 1 to 10 can also be used in a wide range of polymers. Among these are primarily thermoplastic polymers such as polyester, polystyrene, or polyimide, and thermoset polymers such as unsaturated polyester resins, epoxy resins, polyurethanes, and acrylates.

Suitable polyesters derive from dicarboxylic acids and esters of these and from dials, and/or from hydroxycarboxylic acids, or from the corresponding lactones. It is particularly preferable to use terephthalic acid and ethylene glycol, propane-1,3-dial, and butane-1,3-diol.

Suitable polyesters are inter alia polyethylene terephthalate, polybutylene terephthalate (Cefanex® 2500, Celanex® 2002, Celanese; Ultradur®, BASF), poly-1,4-dimethylolcyclohexane terephthalate, polyhydroxy benzoates, and also block polyether esters which derive from polyethers having hydroxy end groups; and also polyesters modified by polycarbonates or by MBS.

The pulverulent coated flame retardants of the invention as claimed in one or more of claims 1 to 10 can moreover be used correspondingly in or on textiles, without impairing their properties.

The flame retardants of the invention can be applied to flexible, in particular textile materials with random distribution or in a certain pattern, e.g. in the form of spots. Textiles of this type are used by way of example in the fitting-out of interiors of hotels, theaters, and conference centers, and also in means of transport (bus, train, car, aircraft, etc.).

The flame retardants of the invention can be used together with other flame retardants, for example those described under the keyword “Flammschutzmittel” [Flame retardant] and elsewhere in Römpps Chemie-Lexikon [Römpp's chemical encyclopedia], 10th edn., (1996).

In general terms, the flame retardants of the invention can act alone or together with other substances to promote carbonization, to starve a fire of oxygen, to form a barrier layer, to form an insulating layer, and to provide other effects.

For all of the above mentioned applications in polymers, in particular in olefins, and also in, or for, intumescent coatings that form insulating layers, and for textiles, it is possible to add other additives to the flame-retardant systems or to the materials, in particular antioxidants, antistatic agents, blowing agents, other flame retardants, heat stabilizers, impact modifiers, processing aids, lubricants, light stabilizers, antidrip agents, compatibilizers, reinforcing materials, fillers, nucleating agents, laser-marking additives, hydrolysis stabilizers, chain extenders, color pigments, and/or plasticizers.

The examples below illustrate the invention.

Determination of Water-Solubility

For the determination of water-solubility, a 10% by weight suspension of the flame retardant was produced in water at 25° C., stirred, and filtered. The dry residue of the filtrate, based on the input quantity, corresponds to the water-solubility of this flame retardant.

Determination of Viscosity

For determination of viscosity, a 10% by weight suspension of the flame retardant was produced in water at 25° C., and stirred. A Brookfield viscometer was used to determine viscosity.

Materials Used

KiON®-HTA1500 AZ from Electronic Materials,

KiON® ML33 AZ from Electronic Materials

Dynasylan® OCTEO from Evonik

### EXAMPLE 1

100 g of ammonium polyphosphate were sprayed, while in motion in a mixer, with 10 g of KiON-HTA1500-butyl acetate solution, and mixed for a further 30 min. The mixture was then dried at 130° C. for 20 min. Table 1 lists the water-solubility values.

### EXAMPLE 2

100 g of ammonium polyphosphate were sprayed, while in motion in a mixer, with 20 g of KiON-HTA1500-hexane solution, and mixed for a further 30 min. The mixture was then dried at 180° C. for 20 min. Table 1 lists the water-solubility values.

### EXAMPLE 3

300 g of ammonium polyphosphate were sprayed, while in motion in a mixer, with 30 g of KiON ML33-butyl acetate solution, and mixed for a further 30 min. The mixture was then dried at 180° C. for 30 min. Table 1 lists the water-solubility and viscosity values.

### EXAMPLE 4

### Comparison

100 g of ammonium polyphosphate were sprayed, while in motion in a mixer, with 20 g of Dynasylan OCTEO-ethanol solution, and mixed for a further 30 min. The mixture was then dried at 180° C. for 20 min. Table 1 lists the water-solubility and viscosity values.

### EXAMPLE 5

The procedure was analogous to that of example 4, but 20 g of a 1:1 mixture of Dynasylan OCTEO-KiON ML33-ethanol solution were used. Table 1 lists the water-solubility and viscosity values.

TABLE 1
Water-solubility (10% by weight suspension, 25° C.)
and viscosity (10% by weight suspension, 25° C.)

| | Water-solubility | Viscosity |
|---|---|---|
| Flame retardant | [%] | [mPa*s] |
| Ammonium polyphosphate, | 0.40 | 43 |
| untreated | | |
| Example 1 | 0.09 | n.d.* |
| Example 2 | 0.05 | n.d.* |
| Example 3 | 0.20 | 22 |
| Example 4 (comparison) | 0.26 | 37 |
| Example 5 | 0.13 | 25 |

n.d.*: not determined

As table 1 shows, the water-solubility of the flame retardants of the invention can be greatly reduced in comparison with the comparative example.

Admixture of silazane to a coating using organosiloxanes can greatly reduce water-solubility in comparison with the coating using only siloxanes.

The viscosity of the flame retardant is reduced by coating with silazanes and, respectively, with silazane-organosiloxane mixture. This makes it easier to produce intumescent paints, since there is by way of example little resultant effect on the viscosity of these.

Weight loss during storage in water was moreover measured. Here, a test sample made of flame-retardant polypropylene was produced by means of extrusion. This was weighed and stored in water in a stirred bath controlled to a temperature of 25° C. After 30 days, the test samples were first dried at 80° C. for 48 hours and then reweighed. The loss of mass was measured.

TABLE 2
Weight loss during storage in water

| | Weight loss during |
|---|---|
| Flame retardant | storage in water [%] |
| Ammonium polyphosphate, | 1.5 |
| untreated | |
| Example 2 | 0.2 |
| Example 4 | 0.8 |
| Example 5 | 0.4 |

By virtue of the lower water-solubility, the coated flame retardants of the invention are suitable for use in polyolefins, for example polyethylene, polypropylene, and in polyester, etc., and in textile applications. By way of example, use of coated ammonium polyphosphate in polypropylene reduces migration in comparison with untreated ammonium polyphosphate.

By virtue of the abovementioned lower water-solubility, the coated flame retardants of the invention are also in particular suitable for use in intumescent coatings, especially in the outdoor sector and in locations requiring high weathering resistance.

1. A pulverulent coated flame retardant comprising a phosphorus-containing and/or nitrogen-containing flame retardant wherein the silazanes and/or silazane-organosiloxane mixtures are used as coating material.

2. The pulverulent coated flame retardant as claimed in claim 1, wherein the phosphorus-containing and/or nitrogen-containing flame retardant is ammonium orthophosphate, ammonium diphosphate, ammonium polyphosphate, melamine phosphate, melamine orthophosphate, melamine diphosphate, melamine polyphosphate, melamine pyrophosphate, melamine borate, melamine cyanurate, melamine borophosphate, melamine 1,X-phthalate, and/or melamine oxalate; melem, melam, melon, melam polyphosphate, melem polyphosphate and/or melon polyphosphate.

3. The pulverulent coated flame retardant as claimed in claim 1, wherein the phosphorus-containing and/or nitrogen-containing flame retardant is ammonium diphosphate and/or ammonium polyphosphate.

4. The pulverulent coated flame retardant as claimed in one claim 1, wherein the silazanes used comprise dimeric and/or polymeric silazanes of the formula (1)
—(SiR′R″—NR′″)ₙ— (1)
where R′, R″, and R′″ are identical or different and are mutually independently hydrogen or an optionally substituted alkyl, aryl, vinyl, or (trialkoxysilyl)alkyl moiety, where n is an integer and n is such that the number-average molar mass of the silazane is from 70 to 150 000 g/mol.

5. The pulverulent coated flame retardant as claimed in one or more of claim 1, wherein the silazanes used comprise those of the formula (2),
—(SiR′R″—NR′″)ₙ—(SiR*R**—NR***)ₚ— (2)
wherein R′, R″, R′″, R*, R**, and R*** are mutually independently and are hydrogen or an optionally substituted alkyl, aryl, vinyl, or (trialkoxysilyl)alkyl moiety, and n and p are such that the number-average molar mass of the silazane is from 150 to 150 000 g/mol.

6. The pulverulent coated flame retardant as claimed in claim 6, wherein R′, R″, R′″, R*, R**, and R*** in the silazane of the formula (1) and/or formula (2) are mutually independently a moiety from the group of hydrogen, methyl, ethyl, propyl, isopropyl, butyl, isobutyl, tert-butyl, phenyl, vinyl, or 3-(triethoxysilyl)propyl, 3-(trimethoxysilyl)propyl.

7. The pulverulent coated flame retardant as claimed in claim 5, wherein, in the silazane of the formula (2),
R′, R′″, and R*** are hydrogen and R″, R*, and R** are methyl and/or vinyl, or
R′ and R′″ are hydrogen, R″, R*, and R** are methyl and R*** is (trialkoxysilyl)propyl, or
R′, R′″, R*, and R*** are hydrogen, and R″ and R** are methyl.

8. The pulverulent coated flame retardant as claimed in claim 1, wherein the organosiloxane of the silazane-organosiloxane mixtures is alkoxysiloxane and/or oligomeric alkoxysiloxane comprising linear, branched, functionalized, and/or cyclic alkyl, alkoxy, aminoalkyl, aryl and/or vinyl groups.

9. The pulverulent coated flame retardant as claimed in claim 1, wherein the organosiloxane is 3-aminopropyltrialkoxysilane, 3-aminopropylmethyldialkoxysilane, 3-glycidyloxypropyltrialkoxysilane, 3-acryloxypropyltrialkoxysilane, 3-methacryloxypropyltrialkoxysilane, vinyltrialkoxysilane, vinyl-tris(2-methoxyethoxy)silane, propyltrialkoxysilane, butyltrialkoxysilane, pentyltrialkoxysilane, hexyltrialkoxysilane, heptyltrialkoxysilane, octyltrialkoxysilane, propylmethyldialkoxysilane, butylmethyldialkoxysilane, and/or phenyltrialkoxysilane, phenylmethyldialkoxysilane, and/or is an oligomeric vinyl-functional, aryl-functional, and/or alkyl-functional alkoxysiloxane.

10. The pulverulent coated flame retardant as claimed claim 1, wherein from 1 to 50 parts by weight of the silazane or of a mixture of silazane and organosiloxane are applied to 100 parts by weight of flame retardant.

11. A process for the production of a pulverulent coated flame retardant as claimed in claim 1, comprising the step of applying the silazanes and/or silazane-organosiloxane mixtures directly or in the form of a solution to the pulverulent flame retardant.

12. The process as claimed in claim 11, wherein the silazanes and/or silazane-organosiloxane mixtures are applied by spraying or injection, or in droplet form, or by pouring onto the pulverulent flame retardants kept in motion via mixers, kneaders, stirrers, or gas.

13. The process as claimed in claim 11, wherein the temperature of the pulverulent flame retardant has been controlled in advance to from 10 to 200° C.

14. The process as claimed in claim 13, wherein hardening is then carried out for from 5 min to 24 h at temperatures of from 10 to 200° C.

15. A process for the production of a pulverulent coated flame retardant as claimed in claim 1, comprising the steps of suspending the flame retardant in a solvent and heating with the silazanes and/or silazane-organosiloxane mixtures to from 10 to 200° C. for from 5 min to 24 h, with stirring.

16. The process as claimed in claim 15, wherein hardening is then carried out for from 5 min to 24 h at temperatures of from 10 to 200° C.

17. The process as claimed in claim 11, wherein the ratio by weight of silazane to organosiloxane is from 100:0 to 1:99.

18. The process as claimed in claim 11, wherein the ratio by weight of silazane to organosiloxane is from 75:25 to 1:99.

19. An intumescent coating, polyolefin and other polymers comprising the pulverulent coated flame retardant as claimed in claim 1.
